(19) United States
(12) Patent Application Publication
(10) Pub. No.: US 2023/0093990 A1
(43) Pub. Date: Mar. 30, 2023

(54) SINGING OF BRAIN - MUSIC THERAPY FOR ALZHEIMER PATIENT

(71) Applicant: Arul Shrivastav, Miami Beach, FL (US)

(72) Inventor: Arul Shrivastav, Miami Beach, FL (US)

(21) Appl. No.: 17/480,713

(22) Filed: Sep. 21, 2021

(51) Int. Cl. G06F 3/16; H04R 3/00

(52) U.S. Cl. CPC G06F 3/165; G06F 3/162; H04R 3/00; H04R 2430/01

(57) ABSTRACT

A musical system for palliating the effects of Alzheimer’s disease comprising a plurality of switches, operable to be controlled by a user to modulate live playback. A minicomputer board is provided that is operable to be connected to the plurality of switches, plurality of drivers and at least an amplifier, the drivers and amplifier being connected to the microcomputer board, the drivers and amplifier being operable to connect to external musical sources such as Volumio and RuneAudio, the microcomputer being operable to convert digital signals to loudspeakers for the benefit of patients. Plurality of Printed Circuit Boards control voltages and overall circuitry and to ensure limits for at least one lithium ion battery pack, the amplifier including digital to analog conversion. The drivers amplifying the line signal and applying gain to have a strong output signal. The musical output is operable to provide palliating effects for Alzheimer’s patients.

### BACKGROUND OF THE INVENTION

Dynamo is a speaker optimized for palliating the effects of Alzheimer’s disease, also known as senile dementia. In the United States, according to medicalnewstoday.com, out of the top five deadliest diseases, only two are incurable. One of these two is Alzheimer’s disease, which affects around ten percent of all Americans above sixty-two and thirty-nine percent above eighty-five. There are various types of drugs such as Donepezil, Rivastigmine, and Galantamine And non-drug related treatments that can be utilized to mitigate the detrimental effects of Alzheimer’s disease, one of which is musical therapy. The study of non-drug treatments' effectiveness in alleviating the ramifications of neurological disorders has shown promise in the visual and auditory arts fields. With Computer-Aided-Design (CAD) utilization, Dynamo has identified and replicated the optimal chamber sizes, material, amplifier, drivers, feedback loop and user experience specifications, and mini-computer boards needed to best address Alzheimer’s disease. With the integration of a preliminary survey, users can input specifications such as their age, ethnicity, and gender, which are then processed in a program. Using a feedback loop, including face detection APIs and tactile-based emotion sensors, the effects of music therapy on the patient are continuously examined, and song choices are accordingly refined. The additions of a Raspberry Pi mini-board computer and the HiFiBerry amplifier board are meant to control user inputs such as volume and power and manage connections to other devices to play the music. Seeing as there is no current cure for Alzheimer’s disease, the relatively new field of music therapy may provide solace and open new pathways into the world’s current understanding of neurology -which Dynamo is an enabler of.

While it is commonly known that Alzheimer’s disease is one of America’s deadliest diseases and is currently incurable, it also has had the greatest increase in diagnostic rates in the past five years. While certain medications can temporarily slow down the progression of the disease, they often accompany overlooked side effects, are unaffordable for a majority of the victims of the disease, and tend to wear off after just a few months. Music therapy, a relatively unexplored part of general non-drug treatments, has been proven to be largely effective in slowing down the progression of Alzheimer’s. Even when studies have been conducted on utilising music therapy for this cause, more effort is spent on the science behind picking a specific song rather than the means by which the song is played. When a song is played for a patient of Alzhiemer’s, minute details including the location and size of knobs or the colour of the wood can have an immense impact on the patient’s disposition. The Dynamo loudspeaker aims to tackle a problem which has not been addressed before — the optimization of the loudspeaker itself for Alzhiemer’s. While introductory research has been conducted into the impact of room acoustics and specific frequencies on Alzheimer’s patients, no attempts have been made at researching how every part of a loudspeaker may affect the patient. Dynamo is the first to individually analyze each part of the loudspeaker, including but not limited to: the frequency response and impedance of the drivers, whether the driver chamber should be vented or ported, how heavy the speaker could be, the type and colour of wood used, the layout and location of the control panel (knobs, switches, sliders), and the type of song played. Hence, despite the vital and developing research being conducted in the field of music therapy and its applications in dementia, it is also essential to understand the effects of the medium by which the song is being played.

Alzheimer’s disease, or senile dementia, is a disease that harms a human’s memory and other mental abilities due to the degeneration of brain cells (neurons). Neurons are responsible for interpreting sensory information from the body - those regarding touch, taste, listening, smells, or sight. Thus, Alzheimer’s disease affects the memory of such senses and essentially stops people from functioning independently. This said, most types of dementia only affect short-term memory in those above the age of 60, and so much of the patient’s early life and basic information remains untouched. Hence, it is inferable that to encourage cell repair or mitigate the degeneration of neurons, the remainder of a person’s past is appropriate for revitalizing a patient’s current neurological state and slowing down the wastage of neurotransmitters. An Alzheimer’s patient’s preserved skills include drawing, speaking, listening, and reading. These skills are intact as they are not encompassed by the neurons which handle short-term memory or judgment, which is perhaps why a human’s senses are his most important attribute. If the foundation of a patient’s brain remains strong, In this case, it slows down further deterioration but can allow for new connections between neurons and then allow for the healthy replication of neurons. Synthesis with one of these preserved skills, listening to and playing music, has proven to be successful in alleviating the effects of Alzheimer’s disease. Dynamo has optimized various aspects of a speaker to make sure that it can most efficiently and robustly allow for the impact of music therapy, which has not previously been explored.

The concept of music therapy finds its foundations in early philosophers such as Aristotle and Socrates, originating from Greece. Aristotle believed that music was a form of catharsis for the ancient Greeks. Catharsis is the action of eradicating one’s repressive and unpleasant tendencies in the hope of gaining long-term happiness and fulfillment. The concept of music therapy from the viewpoint of “sad” music employs these ideas in the widely known ‘paradox of tragedy’. The tragedy paradox claims that humans derive pleasure and gain personal satisfaction from experiences in vexatious states; essentially, humans gain happiness from temporary unhappiness. The catharsis and mimesis of unpleasant emotions are said to have various beneficial neurological effects. One such result is that of the significant increase in the production of prolactin-induced melancholic music. Prolactin is a hormone that is mainly known for its responsibility in producing milk in female mammary glands. This said it is also known for regulating the effects of emotion on the human body — specifically those of stress and depression. When Prolactin is released into the endocrine system, it creates a ‘high’ that combats prevailing unpleasant symptoms that prompt this response. Perhaps the most prominent attribute of music is its ability to induce emotions with no relevance to a real-world context. Thus, when Prolactin has been released into the body with no natural stress to combat, the happy feeling prompted by the sad music can stay in the body for a prolonged period.

### SUMMARY OF THE INVENTION

A musical system for palliating the effects of Alzheimer’s disease comprising a plurality of switches, operable to be controlled by a user to modulate live playback. A minicomputer board is provided that is operable to be connected to the plurality of switches, plurality of drivers and at least an amplifier, the drivers and amplifier being connected to the microcomputer board, the drivers and amplifier being operable to connect to external musical sources such as Volumio and RuneAudio, the microcomputer being operable to convert digital signals to loudspeakers for the benefit of patients. Plurality of Printed Circuit Boards control voltages and overall circuitry and to ensure limits for at least one lithium ion battery pack, the amplifier including digital to analog conversion. The drivers amplifying the line signal and applying gain to have a strong output signal. The musical output is operable to provide palliating effects for Alzheimer’s patients.

### BRIEF DESCRIPTION OF THE DRAWINGS

FIG. 1 of the drawings is a perspective detailed view of the blocks connected together

FIG. 2 of the drawings illustrates the flow of the instrument connected.

FIG. 3 of the drawings explains the circuitry of the instrument.

FIG. 4 of the drawing is the rear view of the instrument

FIG. 5 of the drawing is the top view of the instrument

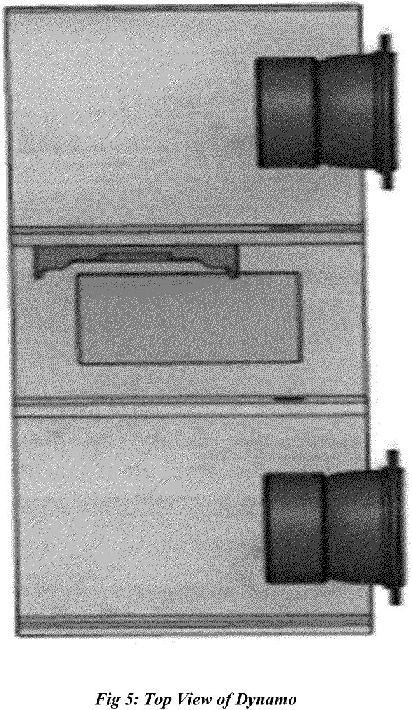

FIG. 6 of the drawing is the Dynamo, An instrument created to flow the music based on frequency range.

FIG. 7 of the drawing shows the audio range of the driver

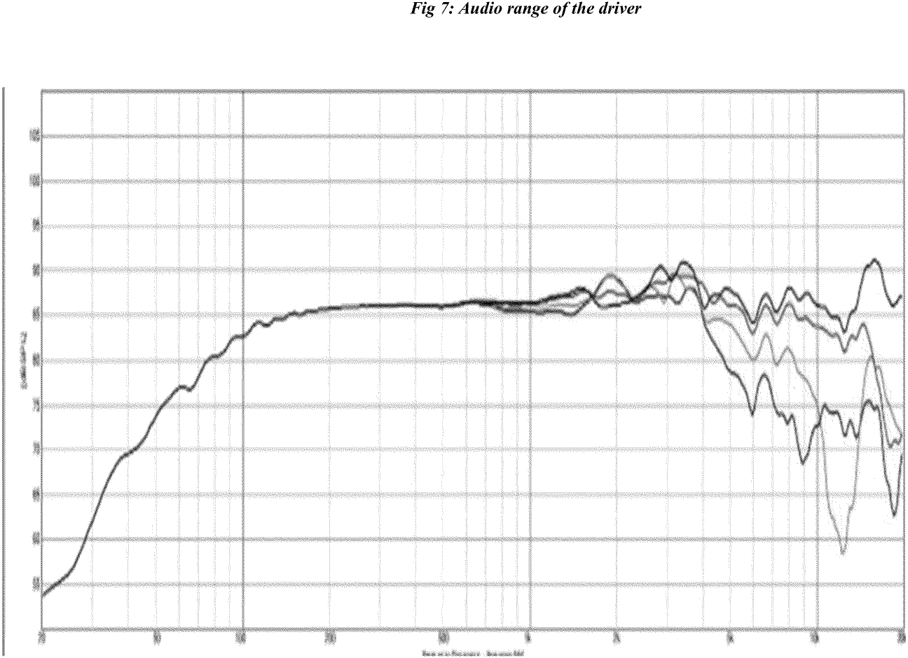

### DETAILED DESCRIPTION OF THE INVENTION

Generally, the idea of music therapy and its effect on the brain follows a particular “BRECVEMA” model. This model is an acronym for the eight significant intended actions which music therapy enhances and by which neuron degeneration is mitigated:
1. Brain-stem reflexes
2. Rhythmic entrainment
3. Evaluative conditioning
4. Contagion
5. Visual Imagery
6. Episodic Memory
7. Musical Expectancy
8. Aesthetic judgement

Brain-stem reflexes are subconscious reflexes that the human body employs intuitively. The most famous act associated with a human’s brain stem is their ability to breathe, swallow, blink, and have a heartbeat. A brain-stem test to determine consciousness and the status of the brain is based on the response of other reflexes. These reflexes include oculocephalic and oculovestibular reflexes — they assess the conjugate turning of the pupils relative to the motion of the head and temperature associated with the side of the head, respectively flinching reflexes. Failure to pass the ‘brain-stem test’ implies that the patient is brain dead or that the amount of neurons that have been damaged is too significant to maintain consciousness. Music therapy aims to halt this severe symptom of Alzheimer’s due to its ability to provoke cell recovery and keep brain-stem reflexes constantly engaged.

In musicology, rhythmic entrainment synchronizes a patient’s bodily rhythms to a particular external tempo. The human rhythm is based on the ‘lub-dub’ of a person’s heartbeat, which regulates the blood flow inside a person’s body. When a patient of senile dementia is reminded of sounds from their childhood, they can replicate the emotions associated with that auditory image and stimulate the neurological regions responsible for the action. It means that by being exposed to rhythm, a patient can replicate actions from times before their neurological-deterioration coming from Alzheimer’s — regardless of whether the neurons in that region have been damaged or not. Most individuals follow the Circadian rhythm — A cycle that tells our brain which chemicals should be released and when certain events should be completed. Many patients of Alzheimer’s disease have reported variegated imitation of the rhythm, so exposure to regulated rhythms can stimulate the regions responsible for the emulation of the Circadian rhythm in the past. Besides the connections with the Circadian rhythm and the patient’s history, the accompaniment of any constant rhythmic track to particular actions can create added efficiency and has been said to add a sense of purpose and direction. In the late stages of dementia, the complement of a specific rhythm to a patient’s daily life can make sure essential, non-voluntary movements — blinking, breathing, and regularity in heartbeats — are continued.

Visual Imagery and Episodic memory work conjointly in storing and rendering specific visual memories. This is perhaps the most extensive and paramount effect of music therapy, as it illustrates the ability of auditory stimulants to restore other independent sensory perceptions. Memories are constantly refreshed due to the chain reaction coming from the recollection of only one memory. When the conscious mind recalls a memory, specific regions of the cerebral cortex work in tangent to add context — done by separately analyzing parts of the singular memory being called upon. Hence, when music therapy can call upon one episode, the brain can call upon other events relating to that episode — which is essentially memory branching.

Evaluative conditioning refers to the change in disposition resulting from a neutral stimulus compared to the neutral stimulus being exposed to another positive or negative stimulation. Evaluative conditioning is perhaps the most common technique used in psychology when referring to non-drug treatments. In terms of music therapy, this technique would signify that the emotion a song bears on a patient would be the patient’s disposition after listening to the song. Dynamo utilizes a feedback loop based on tactile inputs — pressing a button or adjusting a knob to signify their current disposition — and a derivative of Google’s Cloud Vision API (which can detect emotions based on facial expressions). So the speaker’s program can constantly assure that the patient is in an intended mood —presumably a satisfied or happy one - with the application of evaluative conditioning and feedback.

### 3.1 Frequency and Music Therapy

When talking about the pure physics of music, the emotions that our brain interprets from particular sounds or melodies stem from the feelings associated with various frequencies. The interpretation and intended effects of these frequencies are the foundation for the acoustical engineering behind Dynamo. According to various medical studies, constantly listening to frequencies from five hundred to six hundred hertz can encourage cell and DNA repair. In nature, studies have claimed that when a specific amount charges electrons, they are broadcasted across a radius based on their mass and often see positive effects. Various researchers have asserted that these vibrations, which assess the electrons, are replicated by sound in between the frequencies of five hundred hertz and six hundred hertz. The charges caused by these vibrations then enhance the production of antioxidants in the body, which fight against damaging molecules called free radicals. Free radicals are oxygen-filled molecules with an uneven number of unpaired electrons, which can cause cell degeneration.

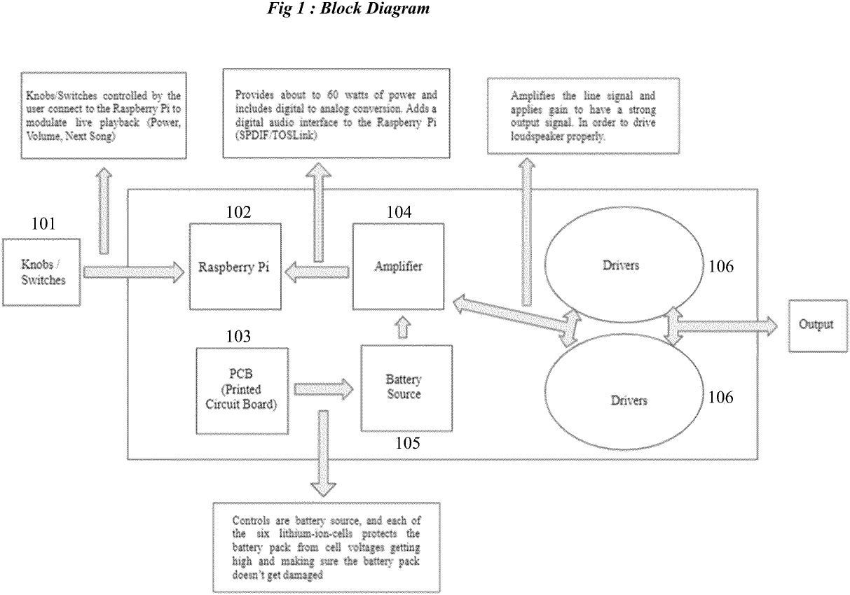

FIG. 1 : Blocks

101 - Knobs/Switch : Knobs/Switches controlled by the user connect to the Raspberry Pi to modulate live playback (Power, Volume, Next Song)

102 - Raspberry pi : A powerful minicomputer board that allows for the connection of the drivers and amplifier to external musical sources such as Volumio and RuneAudio. The raspberry pi, with the help of the knobs and switches acts as a mediator between the driver and the music player as along with the amplifier it converts the digital signals from the audio players into analog signals for the loudspeaker to play for patients.

103 - PCB: Printed Circuit Boards (PCB) control the voltages and overall circuitry. It ensures the lithium ion battery source does not exceed any limits and takes action so that the battery source keeps on working safely and efficiently. It can support up to 50 amps and is an attachment to the lithium-ion battery pack.

104 - Amplifier : Provides about 60 watts of power and includes digital to analog conversion. Adds a digital audio interface to the Raspberry Pi (SPDIF/TOSLink)

105 - Battery Source : Controls are battery source, and each of the six lithium-ion cells protects the battery pack from cell voltages getting high and making sure the battery pack doesn’t get damaged

106 - Drivers : Amplifies the line signal and applies gain to have a strong output signal. In order to drive the loudspeaker properly.

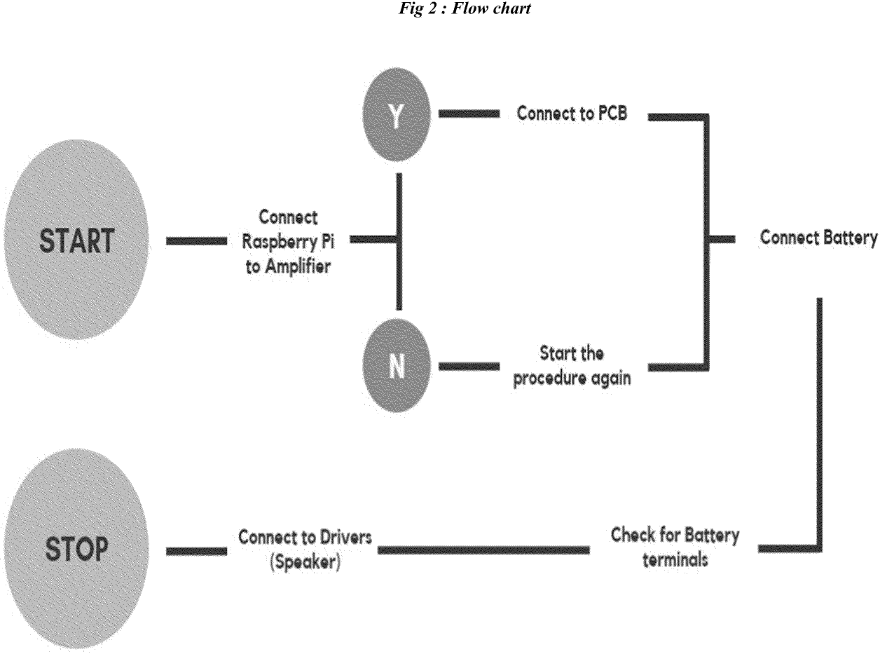

FIG. 2 : Flow diagram refers to initial steps which indicate the function of an instrument and how well they are interdependent to each other. It is a representation of the circuitry and flow of electricity inside the loudspeaker, which allows for seamless control of the speaker.

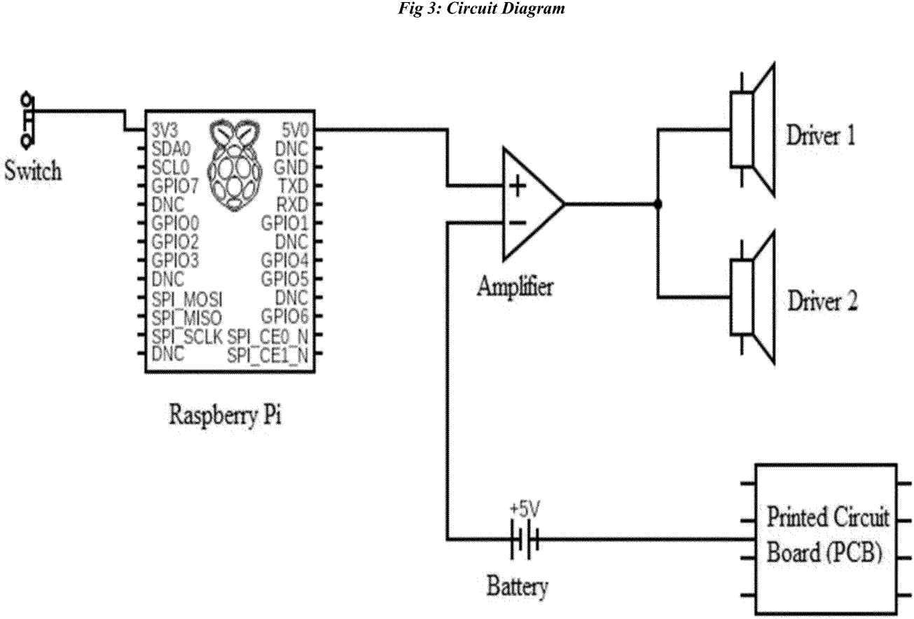

FIG. 3 : The hifi berry amplifier provides up to sixty watts of power, which is appropriate for the driver — which has a Root mean square (RMS) power handling capacity of 30 watts. The fact that the amplifier provides more power than the RMS power handling capacity of the driver is essential as it ensures that audio-clipping is avoided. While the Raspberry Pi has a built-in audio system — mitigating the need for a Digital to Analog Converter (DAC) — the addition of an amplifier is suitable for the speaker’s music therapy intentions — and also acts as a DAC in itself. Amplifiers generally provide more outstanding sound quality due to the additional power provided. However, they also add to a more excellent range of dynamics. Dynamics — how loud or soft a piece is played — are a significant factor in ensuring that evaluative conditioning is utilized and emotional contagion is conveyed in an intended manner; if the song has irregular, unintended changes in volume, it may dishevel rhythmic entrainment or evaluative conditioning practices previously established or currently in practice. The amplifier is placed as a hat on top of the raspberry pi. The raspberry pi, as aforementioned, is used to control the playback of the music — including what song to play, the volume of the speaker, and connection to feedback loop interpreters. To play music through the raspberry pi, an external digital audio player needs to be flashed onto the SD card of the raspberry pi. Volumio is an OS audio player that deals with the same and connects to the internet to play the chosen songs. The raspberry pi then connects to a PCB board built with a Battery Managerial System (BMS) soldered onto the underside of the top panel of the middle chamber. This board allows various toggle switches and knobs on the top of the central section to be attached to the raspberry pi. These switches and knobs have been specifically chosen to ensure easy access, minimal accidental inputs, and marginal utility for the patients. Finally, the amplifier/raspberry pi system is powered by six series 18650 Lithium-ion batteries, which have a maximum output of twenty-two volts. The recommended power supply for the system is twelve to twenty-four volts. This battery series connects to the PCB board with the in-built BMS, which regulates the battery’s output and ensures safe and efficient operation.

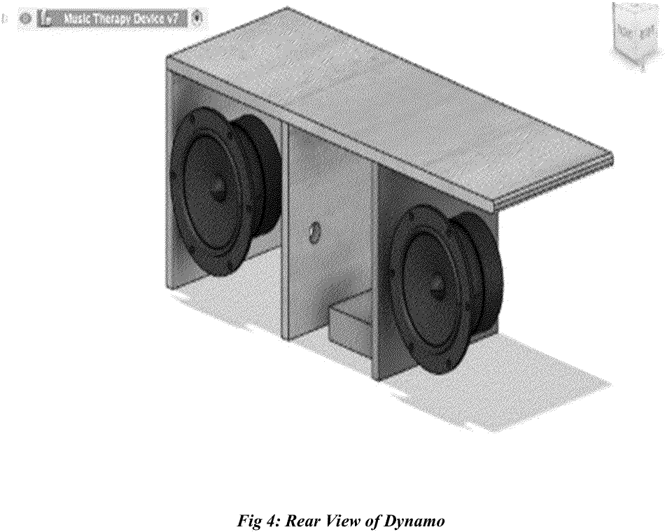

FIGS. 4 & 5 : The enclosure is made primarily of medium-density fibreboard (MDF) wood. This wood was chosen explicitly for Dynamo due to its high sound-soaking capabilities and thus its low distortion ratios. Generally speaking, MDF is one of the densest fibreboards, with a density of around 700 kg/m for this speaker specifically. The wood is also known to be incredibly homogenous, which means it maintains its consistency and fluidity (in texture and density) throughout, adding more excellent balance to the sound quality. Finally, the original color and texture of MDF shares optimal characteristics with comfort and neuron-enhancing tests taken by a large range of dementia patients — specifically in its porosity and conductibility ratios.

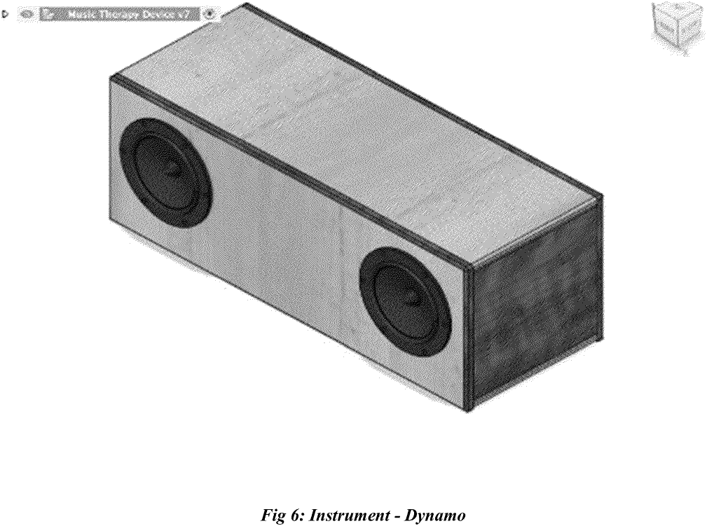

FIG. 6 : Dynamo’s enclosure features three chambers - the two chambers on the speaker’s side featuring the two drivers and the middle featuring the other electronic equipment, including the battery, raspberry-pi, and hifi berry amplifier. The enclosure has a height of 141 mm, a width of 387 mm, and a length of 147 mm. The section is further divided into three chambers - the left, right, and middle. The middle chamber holds the majority of the electronic equipment for a balanced distribution of weight, containing the Raspberry Pi and the HiFi berry amplifier on the floor and the PCB battery board and 18650 six-pack Lithium battery set on the roof and back wall, respectively.

FIG. 8 : Dynamo’s speaker utilizes 2 of Dayton Audio’s RS 100-4 4” Full Range Drivers. A driver is an individual loudspeaker whose primary function is to convert electric signals into sound waves and transmit them. The RS100 was explicitly picked due to its specifications and appropriateness in size relative to the speaker itself. The frequency response of a driver is indicative of its quality and efficiency. Essentially, frequency response conveys the ability of a driver to accurately and consistently produce sounds from various ranges of frequencies. The frequency response of the RS 100 driver has an impressive frequency response, with the bass range response (20 - 500 Hz) increasing proportionally with output (in decibels) and the curve smoothening in the mid-range to provide consistency in dynamics. The treble range features four distinct lines, each representing phase angles. The various phase angles (black is zero degrees, red is fifteen degrees, green is thirty degrees, and blue is forty-five degrees) indicate the time delay in the sinusoidal wave of the frequency carries. This delay, known as phase delay, occurs at these high frequencies - hence the four frequency response curves at the treble range.

FIG. 9 : The impedance graph above depicts how resistance varies as a function of frequency. Resistance is highest at a particular “free-air resonant frequency” (Fs) — in this case, it is 84.8 Hz. The Free-air resonant frequency of a driver is the point at which the suspension of the speaker balances out the movement of the speaker’s components. This frequency defines a usable range for the driver, reducing or nullifying ringing sounds from an unstable driver. This equilibrium point is a result of the increased resistance. The DC resistance of the speaker (Re) is also less than the nominal impedance (3 and 4 respectively) due to the nominal impedance being the DC resistance plus resistance in the AC circuit of the driver. As seen in the graph, impedance is maintained at Re level until Fs is reached. After the peak, it returns to Re until 1,000 Hz; this is because coil inductance is measured at this point — 0.28 mH for this driver. After 1,000 Hz, impedance increases due to the added inductance.

Dynamo also features a vent/port rather than a pure sealed enclosure. It was due to various reasons, including the preliminary size of the enclosure (a larger chamber would require a vent) and the recommendation of a calculator that looked at the Qes, the diameter of the driver, and the Efficiency Bandwidth Product of the speaker. After deciding to feature a vented enclosure, the equivalent volume (VAS), Free air resonance (Fs), and Qts were put in another calculator, which came up with the preliminary specifications of the enclosure.

What is claimed is:

1. A musical system for palliating the effects of Alzheimer’s disease comprising:
a plurality of switches, operable to be controlled by a user to modulate live playback;
a minicomputer board, operable to be connected to the plurality of switches, plurality of drivers and at least an amplifier, the drivers and amplifier being connected to the microcomputer board, the drivers and amplifier being operable to connect to external musical sources such as Volumio and RuneAudio, the microcomputer being operable to convert digital signals to loudspeakers for the benefit of patients;
plurality of Printed Circuit Boards to control voltages and overall circuitry and to ensure limits for at least one lithium ion battery pack;
the amplifier including digital to analog conversion;
the drivers amplifying the line signal and applying gain to have a strong output signal,
wherein musical output is operable to provide palliating effects for Alzheimer’s patients.
